(19) United States
(12) Patent Application Publication
(10) Pub. No.: US 2017/0138821 A1
(43) Pub. Date: May 18, 2017

(54) Method of Use of Rules-Based Telematics Device for Auditing Maintenance Functions

(71) Applicant: Daniel L. Carey, Sugar Hill, GA (US)

(72) Inventor: Daniel L. Carey, Sugar Hill, GA (US)

(21) Appl. No.: 14/944,435

(22) Filed: Nov. 18, 2015

(51) Int. Cl. G01M 99/00

(52) U.S. Cl. CPC G01M 99/005

(57) ABSTRACT

The invention is a computer-implemented method to analyze compliance between maintenance contracts and delivery of maintenance and to analyze compliance between the delivery of maintenance and compliance with rules and standards. A telematics device is taken by a technician while inspecting and maintaining a control unit. The device later communicates with a computer to analyze whether the contracted actions were taken and whether the maintenance meets rules and standards. The telematics device is tamper resistant providing a high degree of certainty to the compliance data that is produced.

The control unit can be an elevator, escalator, other type of capital equipment, or a secured facility or secured route. The method is illustrated through use with an elevator for illustrative purposes but the use of the method is not limited in any way to use on elevators.

### CROSS-REFERENCE TO RELATED APPLICATIONS

N/A

### STATEMENT REGARDING FEDERALLY SPONSORED RESEARCH OR DEVELOPMENT (IF APPLICABLE)

N/A

### REFERENCE TO SEQUENCE LISTING, A TABLE, OR A COMPUTER PROGRAM LISTING COMPACT DISC APPENDIX (IF APPLICABLE)

N/A

### BACKGROUND OF THE INVENTION

The invention relates to a method of using a rules-based telematics device for auditing maintenance functions.

### BRIEF SUMMARY OF THE INVENTION

The invention is a computer-implemented method to analyze compliance between maintenance contracts and delivery of maintenance and to analyze compliance between the delivery of maintenance and compliance with rules and standards. A telematics device is taken by a technician through inspecting and maintaining a control unit. The device later communicates with a computer to analyze whether the contracted actions were taken and whether the maintenance meets rules and standards. The telematics device is tamper resistant providing a high degree of certainty to the compliance data that is produced.

The control unit can be an elevator, escalator or moving walk, power driven stairways and walkways, hoisting and lowering mechanisms, dumbwaiters, material lifts or other type of capital equipment, or a secured facility or secured route. The method is illustrated through use with an elevator for illustrative purposes but the use of the method is not limited in any way to use on elevators.

### BRIEF DESCRIPTION OF THE SEVERAL VIEWS OF THE DRAWING

FIG. 1 is a drawing of an elevator with a plurality of maintenance checkpoints corresponding to key components of the elevator.

### DETAILED DESCRIPTION OF THE INVENTION

Elevators in the United States move more people in one day than all other forms of transportation combined. The elevator industry is a highly specialized industry. It is unlike any other building trade because unless someone is trained in the elevator maintenance field they don't have the knowledge to understand what is actually going on with the safety systems, electrical systems and mechanical systems in elevators. In buildings tall enough to require an elevator, a building manager or building engineer can make decisions and repairs to HVAC problems, electrical problems plumbing problems etc. The only building function that can not be touched by building personnel is the elevator systems.

Elevator systems require trained experienced personnel to maintain, troubleshoot and repair the elevators. Because this is such a specialized industry which requires a trained eye, elevator maintenance people may intentionally or unintentionally mislead building owners and managers.

Preventative maintenance contracts are just one problem area. Most buildings with elevators or escalators have maintenance contracts that require the elevator company to perform the necessary maintenance to adequately keep the elevators operating in a safe reliable manner. Because the building owners and managers do not have elevator knowledge they leave it up to their elevator company to perform the maintenance which is an inherently flawed system.

Elevator maintenance companies may give the elevator maintenance technician more elevators than they can possibly maintain. This allows the company to make more money because they are not performing all of the contracted preventative maintenance.

An example of the high potential for inherent failure of a maintenance contract that is not audited follows: One elevator maintenance technician may be assigned to 150 to 300 elevators per route depending on the type of elevators and the profit motive of the maintenance company. However would if the industry standard for proper elevator maintenance is 1 hour per month for hydraulic elevators (low rise buildings) and 2-2-½ hours per month for Traction elevators (mid to high rise buildings). A technician working 160 hours per month cannot maintain 150-300 elevators per month.

A paper Unit Record Log with boxes checked by a technician does not create a ‘paper trail’ that identifies which checks were rushed or skipped and may not sufficiently create a rules and standards compliance trail to see if the control unit meets industry standards or local or state rules and laws.

This inherent flaw with the prior art leaves the building owners in a vulnerable position. In many state statutes the law regarding elevators place the onerous on the building owners to provide safe operation and proper maintenance of the elevators. The elevator maintenance companies don't have direct responsibility yet they control the maintenance schedule and the extent of the maintenance performed.

The building owners need more detailed knowledge and tamper-resistant knowledge to overcome the inherent deficiencies in the prior art systems of dealing with their elevators and the required maintenance so that they can not only contract and pay far the correct services but also audit the details to make sure that the correct services are being provided and to assure that the services are being provided in a timely manner.

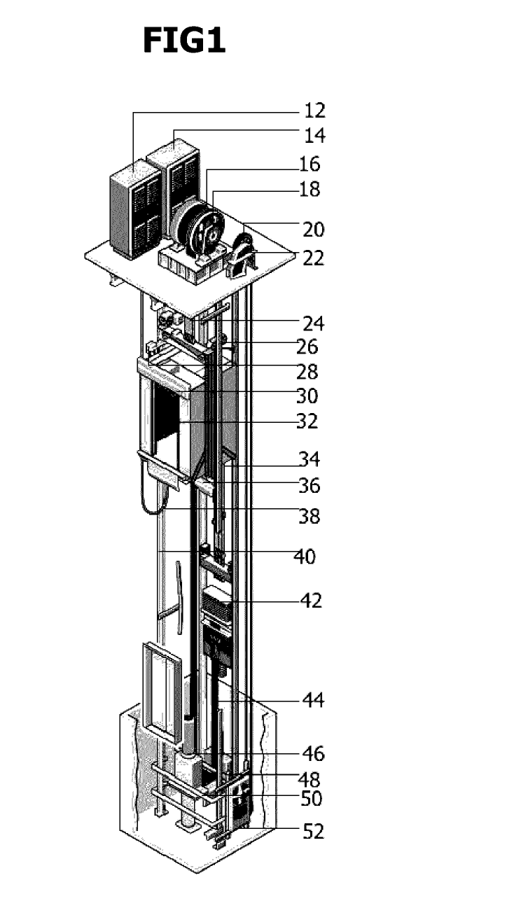

FIG. 1 shows an example of locations of checkpoints for an elevator. These locations are control system 1.2, drive and brake system 14, gearless machine 16, primary velocity transducer, 18, smart primary position transducer 20, governor 22, hoisting ropes, 24, roller guides 26, secondary position transducer 28, door operator 30, entrance-protection system 3, load-weighing transducers 34, car safety device 36, traveling cable 38, elevator rail 40, counterweight 42, compensation ropes 44, car buffer 46, counterweight buffer 48, compensation sheave 50, governor tension sheave 52.

Data can be organized in a variety of manners for any particular control unit. The use of the telematics device with an elevator may produce conditioned data regarding compliance with a particular elevator manufacturers contracts or compliance with ANSI A17.1.

1. A computer-implemented method comprising:
a technician retrieves a telematics device from a resting position;
a control unit has a plurality of checkpoints that relay a plurality of raw data to the telematics device When the technician inspects and maintains the control unit and When the technician brings the telematics device in close proximity to the checkpoints;
the technician returns the telematics device to the resting position after completing inspection and maintenance;
the plurality of raw data from the control unit checkpoints are conditioned and compared to a control unit maintenance performance contract by the computer;
the plurality of raw data from the control unit checkpoints are conditioned and compared to a plurality of rules and compliance standards by the computer;
the computer advances a plurality of performance compliance information.

2. The method of claim 1 wherein the control unit is an elevator.

3. The method of claim 1 wherein the control unit is an escalator.

4. The method of claim 1 wherein the control unit is a secured facility.

5. The method of claim 1 wherein the performance compliance information is compiled, stored and used for control unit management reports.

6. The method of claim 1 wherein the performance compliance information is compiled, configured and transmitted to additional locations for other purposes.

7. The method of claim 1 wherein the raw data is transmitted for auditing purposes.

8. The method of claim 1 wherein the performance compliance information is compiled, configured, and stored for accounting purposes.
